(19) United States
(12) Patent Application Publication
(10) Pub. No.: US 2023/0104165 A1
(43) Pub. Date: Apr. 6, 2023

(54) Module System for Robots

(71) Applicant: Hitachi, Ltd., Chiyoda-ku, Tokyo (JP)

(72) Inventors: Kazushi YAMASHINA, Tokyo (JP); Terunobu FUNATSU, Tokyo (JP); Takashi SAEGUSA, Tokyo (JP)

(21) Appl. No.: 17/910,063

(22) PCT Filed: Dec. 25, 2020
(86) PCT No.: PCT/JP2020/048757

§ 371 Date: Sep. 8, 2022

(30) Foreign Application Priority Data
Mar. 9, 2020 (JP) 2020-039705

(51) Int. Cl. B25J 9/16

(52) U.S. Cl. CPC B25J 9/161; B25J 9/163; B25J 9/1661

(57) ABSTRACT

Provided is a module system for a robot, said module system being suitable for an autonomous robot that switches between onsite operations. A module system for a robot, said module system being linked to a sensor and a mechanism that drives a robot, and said module system controlling the drive mechanism, wherein the module system for a robot is characterized in that: the module system comprises a software processing unit, a logic circuit unit, and an input/output controller that is linked to the drive mechanism and the sensor; the software processing unit stores a switching condition for a plurality of control tasks executed within a series of operation steps in the drive mechanism, as well as a parameter used in a computation task executed during a control task, and also transmits the switching condition and the parameter to the logic circuit unit and designates a subsequent operation step; and the logic circuit unit uses a sensor signal from the input/output controller to confirm that the switching condition has been established and controls the start and end of a plurality of control tasks, temporarily holds the parameter and then uses the parameter in an arithmetic operation task in the designated subsequent operation step, and controls the drive mechanism via the input/output controller in accordance with the result of the arithmetic operation in the arithmetic computation task.

### TECHNICAL FIELD

The present invention relates to a control system, for example, for industrial robots, and, particularly, to a module system for robots which is suitable for robot miniaturization and autonomous robot operation.

### BACKGROUND ART

Robot systems have come to be widely used in various fields. In recent years, particularly, applications have been spreading from indoor uses, for example, in factories, to outdoor uses. Against such a backdrop, expectations have been rising for robot systems operable in narrow spaces or under dynamically varying circumstances.

Generally, such robot systems are each configured with a mechanical system including arms and end effectors provided at arm ends and a control device to control such mechanical parts.

In Patent Literature 1, an example of a control system for such robot systems is described. An object of the control system is to provide technology to allow, when having a system execute a predetermined task using a learning module, the user of the system to perform, during operation execution, adjustment according to operating conditions. The system is provided with a learned model, learned as prescribed through mechanical learning, or a learning module having a model provided with inputs and outputs equivalent to those of the learned model, and is used to have a predetermined task executed. The system is configured including: a first input unit which receives information acquired by one or more external systems and generates at least part of information to be inputted to the learning module; an output unit which acquires information outputted from the learning module and generates information to be outputted from the system, the information to be outputted from the system being for use in execution of a predetermined task; and a second input unit which receives input from the user. Information based on the input from the user is inputted to at least one of the first input unit, the learning module, and the output unit. Information outputted from the output unit varies based on the input from the user.

### CITATION LIST

### Patent Literature

Patent Literature 1: Japanese Unexamined Patent Application Publication No. 2018-190241

### SUMMARY OF INVENTION

### Technical Problem

Because of labor power shortages at work sites, robots are expected as substitutes for labor power, and they are required to offer high levels of sophistication and autonomy. In reality, however, with industrial robots used at work sites widely varying in performance and individuality, there is no easy means for enhancing the autonomy and performance of the existing systems.

If end effectors capable of precision control and autonomous operation can be mounted at end parts of robot arms, control precision and operation speed can be improved, making it easy to realize autonomous robot operation. When doing so, by adopting modularized mechanisms and control systems, wiring arrangement and implementability can be improved.

However, if such modularization results in reducing the space for mounting a control system, a high-performance CPU cannot be mounted. Therefore, a new means for making arithmetic processing required for autonomous robot operation executable is required, but this is not taken into consideration in Patent Literature 1.

Based on the above-described, it is an object of the present invention to provide a module system for robots which is suitable for autonomous robots to substitute for labor power at work sites.

### Solution to Problem

Based on the above-described, the present invention provides a module system for robots which, by being linked to a drive mechanism and a sensor of a robot, controls the drive mechanism. The module system comprises a software processing unit, a logic circuit unit, and an input/output controller linked to the drive mechanism and the sensor. The software processing unit stores switching conditions for switching plural control tasks executed in a series of operation processes to be executed in the drive mechanism and parameters for use in operation tasks executed in the control tasks. The software processing unit also transmits the switching conditions and the parameters to the logic circuit unit and specifies a next operation process to be executed. The logic circuit unit: confirms, based on sensor signals from the input/output controller, establishment of the switching conditions and controls starting and ending of the plurality of control tasks; temporarily retains the parameters and uses the parameters in the operation tasks to be executed in the next operation process specified for execution; and controls, via the input/output controller, the drive mechanism according to operation results of the operation tasks.

### Advantageous Effects of Invention

A module system for robots which is suitable for autonomous robots to substitute for labor power at work sites is provided.

### BRIEF DESCRIPTION OF DRAWINGS

FIG. 1 is a diagram showing an example of a robot system.

FIG. 2 is a diagram showing a configuration of an end effect system.

FIG. 3 is a diagram showing an example of a minimum interior configuration of a master controller.

FIG. 4 is a diagram showing an example of a detailed interior configuration of the master controller.

FIG. 5 is a diagram illustrating a specific operation example of the robot system.

FIG. 6 shows an example of a task switching condition table set in an external main storage device 4A12 from a higher-order control device 3 side.

FIG. 7 indicates example parameters set, for an operation task D3, in the external main storage device 4A12 from the higher-order control device 3 side.

FIG. 8 is a diagram representing, in a time-series manner, operations executed in each part of a master controller 4A.

FIG. 9 is a conceptual diagram of network processing.

FIG. 10 is a diagram representing a specific configuration example of an NN operation unit to perform network processing.

FIG. 11 is a flowchart of a procedure for processing performed by the NN operation unit.

FIG. 12 is a diagram representing average processing time relationships in a series of processing performed in a lower-order control device 4..

### DESCRIPTION OF EMBODIMENTS

In the following, an embodiment of the present invention will be described with reference to drawings.

### First Embodiment

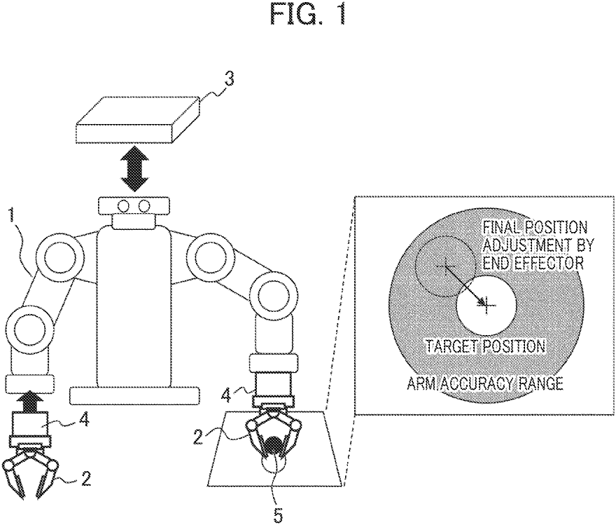

FIG. 1 is a diagram showing an example of a robot system. The robot system shown in FIG. 1 is configured with: a mechanical system which includes arms 1 and hands 2 each provided at an end of each arm 1; and a control system which includes a higher-order control device 3 to mainly control the whole robot system including the arms 1 and lower-order control devices 4 each provided to control each hand 2. The example shown represents a robot system installed with an end effector module and an example manner of robot system operation in which an arm 1 approaches an object 5 while the position of the hand 2 is controlled by the lower-order control device 4 such that the lower-order control device 4 and the hand 2 supplement the control accuracy of the arm 1.

During the operation, the higher-order control device 3 carries out analyses concerning object recognition and operation generation and directs operations while transmitting necessary information to the lower-order control device 4 using a communication means, not shown. The lower-order control device 4 controls the hand 2 according to the directions received. In realizing the lower-order control device 4, the major objects include: speeding up of, delay reduction in, and autonomous control realization for feedback control in downstream systems; and, in the process of achieving such objects, reducing the development man-hours and improving wiring layout and implementability.

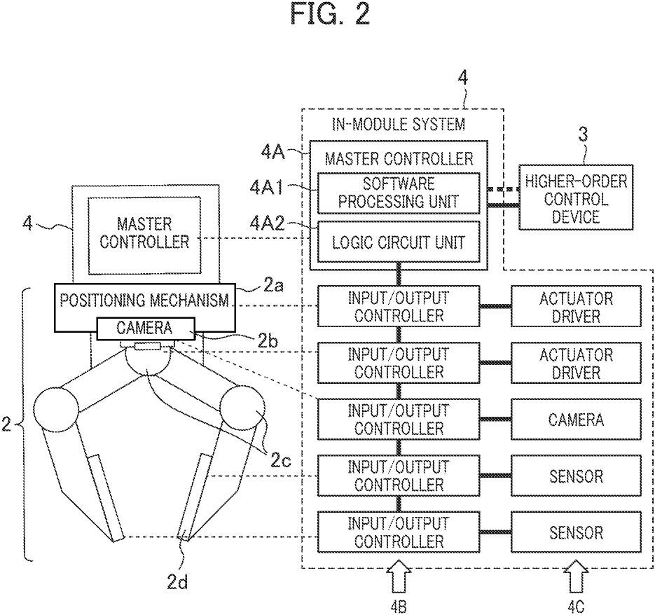

FIG. 2 is a diagram of an end effect system configuration, specifically representing a lower-order control device 4 and a hand 2. In this example, the hand 2 includes a positioning mechanism 2a, a camera 2b, a wrist mechanism 2c to determine positioning, and a gripper mechanism 2d to grip an object. The lower-order control device 4 is provided, for communication with the higher-order control device 3, with a wired communication path, shown in solid line, and a wireless communication path, shown in dotted line.

The lower-order control device 4 is configured mainly with a master controller 4A and has a modular configuration integrating plural input/output controllers 4B and plural sensors 4C including actuator drivers, sensors, and a camera. These controllers and sensors are interconnected via wired communication paths. The plural input/output controllers 4B may be divided, to be respectively configured, into input/output controllers to execute input/output control and communication controllers to execute communication control. According to FIG. 2, the respective mechanisms are each provided with an appropriate actuator driver or an appropriate input/output means such as a sensor or a camera.

As described above, the lower-order control device 4 is a modularized device combining the controller with other controllers and mechanisms with built-in sensors and controllers. This modularized single configuration makes it possible to control, at high speed, position correction and gripping movement. This enables hand parts at ends to operate independently without being dependent on arm forms and arm performance. Thus, the implementation man-hours can be reduced while maintaining safety by reflective end-part control.

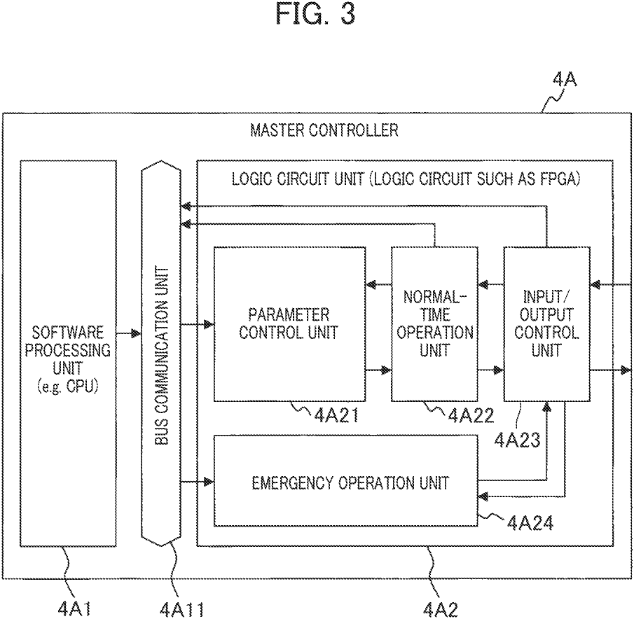

The master controller 4A is configured including a software processing unit 4A1 including a CPU and a logic circuit unit 4A2 including hardware such as an FPGA (field programmable gate array). An example of a minimum internal configuration of the master controller 4A is shown in FIG. 3. Referring to FIG. 3, the software processing unit 4A1 and the logic circuit unit 4A2 are interconnected by a bus communication unit 4A11, and the internal processing function of the logic circuit unit 4A2 is configured including a parameter control unit 4A21, a normal-time operation unit 4A22, an input/output control unit 4A23, and an emergency operation unit 4A24.

In this configuration, command signals issued by the software processing unit 4A1 are transmitted from the bus communication path 4A11 to the input/output control unit 4A23 via the parameter control unit 4A21 and the normal-time operation unit 4A22 to be then supplied from the input/output controller 4B shown in FIG. 2 to the actuator drivers of various parts of the hands 2 to thereby drive the parts. The signals generated by the sensors and the camera provided in various parts of the hands 2 are fed back via the input/output controller 4B to the input/output control unit 4A23 shown in FIG. 3 to be then returned as required, for example, to the bus communication path 4A11, parameter control unit 4A21, normal-time operation unit 4A22, and emergency operation unit 4A24 for use in operations performed by such units. The emergency operation unit 4A24 is assumed to have a configuration basically based on the same concept as of the normal-time operation unit 4A22.

As clear from the configuration shown in FIG. 3, the master controller 4A is a device including an FPGA and a CPU, that is, a single chip integrating a processor and an FPGA. This configuration enables overall performance enhancement by using software for processing suitable for software and hardware for operation suitable for hardware. Also, since time-consuming hardware development work can be minimized, the overall development man-hours can be reduced. Furthermore, the configuration can reduce power consumption.

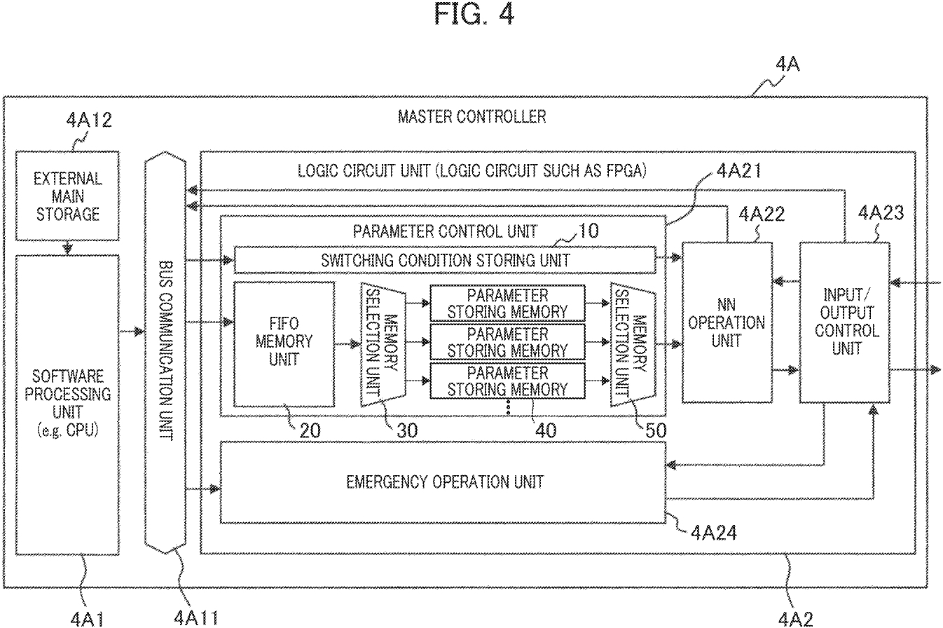

FIG. 4 is a diagram showing an example of a detailed interior configuration of the master controller. According to the example detailed configuration, the parameter control unit 4A21 is configured including a switching condition storing unit 10, an FIFO memory unit 20, a memory selection unit 30, parameter storing memories 40, and a memory selection unit 50. The normal-time operation unit 4A22 is configured including an NN operation unit to perform network processing. Furthermore, the software processing unit 4A1 is connected to an external main storage device 4A12.

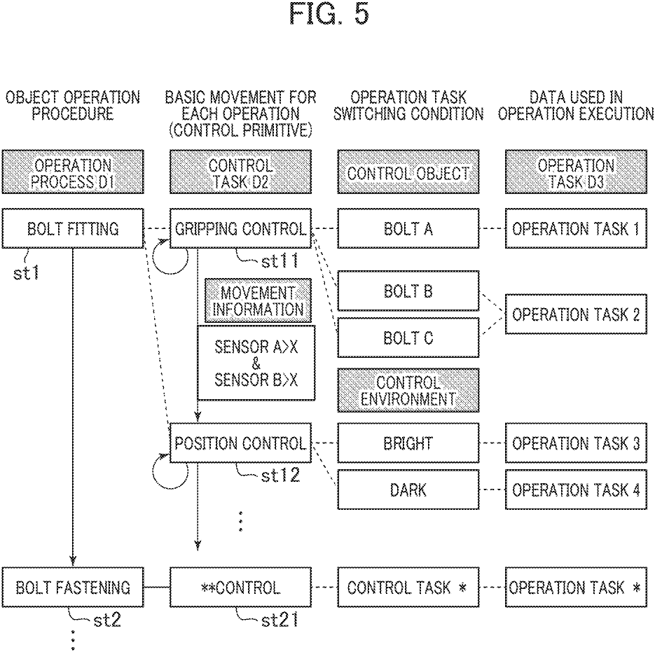

Next, the operations of each part of the master controller will be described referring to specific operation examples of the robot system. According to the specific operations of the robot system represented in FIG. 5, the robot performs plural operation processes in a predetermined order, for example, after executing bolt fitting process st1, proceeding to bolt fastening process st2. Information on the order of execution of operation process D1 is provided as command signals from the software processing unit 4A1 to the parameter control unit 4A21. Namely, concerning the processing sequence, the software processing unit 4A1 serves like a sequencer.

In each operation process D1, plural control tasks D2 are executed. In the bolt fitting process st1, for example, an object gripping control task st11 to use the gripper mechanism 2d of the robot shown in FIG. 2 is executed, and, subsequently, a position control task st12 to use the positioning mechanism 2a and the wrist mechanism 2c is sequentially executed.

Completion of gripping control st11 is confirmed when an operating condition with the values detected by sensor and sensor B both being X or larger is met. The information on this operating condition is provided as a command signal from the software processing unit 4A1 to the switching condition storing unit 10 in the parameter control unit 4A21. In the switching condition storing unit 10, the sensor signals fed back from the input/output controller 4B to the parameter control unit 4A21 via the input/output control unit 4A23 are monitored and, when the above operating condition for switching is met, a next control task is activated. Upon being met of the operating condition, the information stored in the switching condition storing unit 10 is discarded, and the command signal on a new switching condition received from the software processing unit 4A1 is newly stored.

In the gripping control task st11, for example, a bolt is made a control object. The parameters stored in the parameter control unit 4A21 represent feature amount information, for example, about a control object such as a bolt or about a control environment. Furthermore, in the NN operation unit 4A22, operation is carried out based on the parameters. In the present example, parameters for gripping bolts A, B, and C are retained as command signals from the software processing unit 4A1 in plural parameter storing memories 40. The parameters representing feature amounts about bolts A, B, and C are entered in the plural parameter storing memories 40 via the FIFO memory unit 20 and the memory section unit 30, the plural parameter storing memories 40 being used in order from top. In the case of position control, feature amounts representing lightness in bright and dark states are entered in the plural parameter storing memories 40 in order from top. While data is serially processed in the software processing unit 4A1, parallel processing is advantageous in the logic circuit unit 4A2 that is hardware. Hence, parallel-to-serial conversion is made in the FIFO memory unit 20 and the memory selection unit 30.

In the NN operation unit 4A22 to perform neural network operations, operation task D3 is executed using feature amount information obtained from the parameter storing memories 40 and, thereby, an optimum work amount is determined. For bolt A, the operation task 1 is executed. In the case of bolt B or bolt C, the operation task 2 is executed. In a bright state, the operation task 3 is executed and, in a dark state, the operation task 4 is executed. The execution result is transmitted to the input/output controller 4B via the input/output control unit 4A23, causing the relevant mechanisms to be driven and the bolt A to be fastened.

Though not explicitly shown in FIG. 5, like control task switching conditions, operation task switching conditions are also entered, as command signals from the software processing unit 4A1, in the switching condition storing unit 10 in the parameter control unit 4A21, and operation task switching is carried out through a processing procedure similar to the procedure used for control task switching.

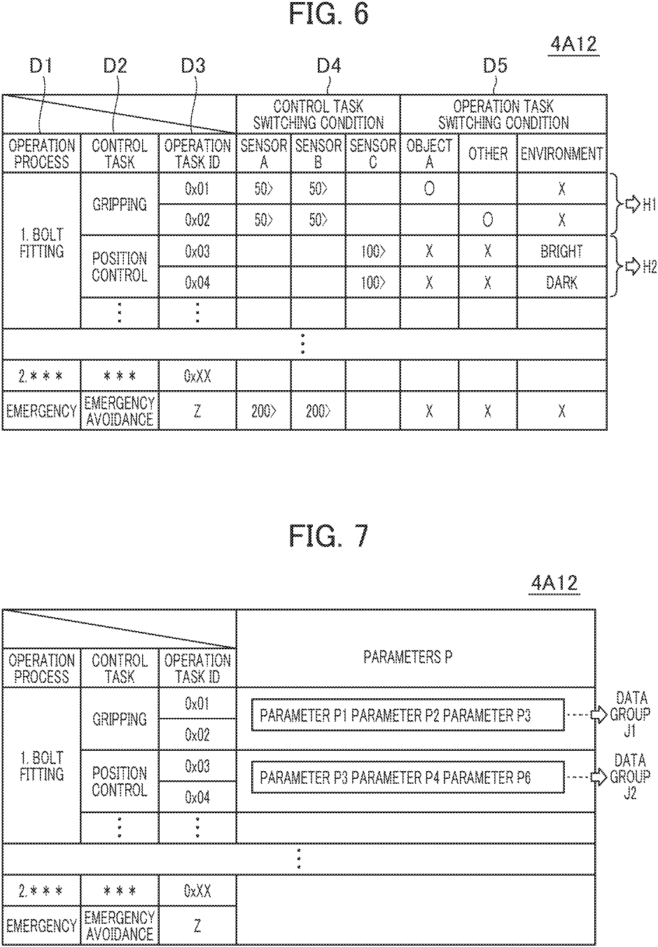

FIG. 6 shows an example of a task switching condition table set in the external main storage device 4A12 from the higher-order control device 3 side. In the table, the operation process D1, control task D2, and operation task D3 are described in this order from left, and control task switching conditions D4 and operation task switching conditions D5 are also indicated. For example, it is indicated that the operation task ID for bolt A gripping operation is 0X01 and that the control task switching condition D3 for confirming completion of the task is the values detected by sensors A and B both being 50% or over. When the condition is met, execution of the operation task for bolt B gripping operation represented by operation task ID 0X02 is started. The execution of each control task includes the execution of plural operation tasks. In the table of FIG. 6, operation task switching conditions for confirming operation task completion are also indicated. In the table, how the operation to be executed using the emergency operation unit 4A24 in a time of emergency is also similarly indicated, but description will be omitted herein.

FIG. 7 indicates example parameters set, for the operation task D3, in the external main storage device 4A12 from the higher-order control device 3 side. In FIG. 7, the operation process D1, control task D2, and operation task D3 are described in this order from left. For example, the ID of an operation task for bolt gripping operation is 0X01, and parameters P1, P2, and P3 for use in bolt gripping operation tasks (operation task 1 for bolt A and operation task 2 for bolts B and C) are indicated as a group of data representing serial information.

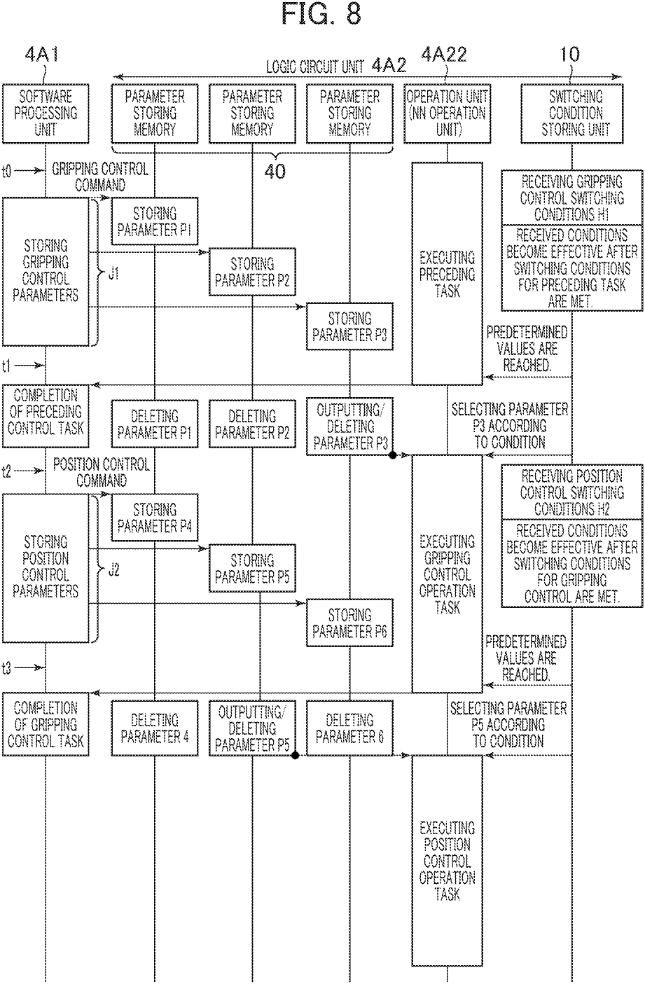

FIG. 8 is a diagram representing, in a time-series manner, operations executed in each part of the master controller 4A. In the following, the operations of each part will be described with reference to the diagram. In a top part of the diagram, the software processing unit 4A1, plural parameter storing memories 40, operation unit 4A22, and switching condition storing unit 10 are indicated in this order from left.

In the diagram, the height direction represents a time series. At time t0, the software processing unit 4A1 issues a gripping control command for a bolt fitting operation process indicated in FIG. 5 and, subsequently, also issues a position control command for the bolt fitting operation process. More specifically, the software processing unit 4A1 issues a gripping control command to the logic circuit unit 4A2 at time t0, receives a signal confirming completion of the preceding task from the logic circuit unit 4A2 at time t1, issues a position control command to the logic circuit unit 4A2 at time t2, and receives a signal confirming completion of the gripping control task from the logic circuit unit 4A2 at time t3.

At time t0 at the beginning of this time series when the software processing unit 4A1 issues a gripping control command, the operation unit 4A22 is engaged in execution of the preceding task in the stage preceding the gripping control and the switching condition storing unit 10 is in the process of determining whether the condition for switching the preceding task in the stage preceding the gripping control has been met. Namely, while the operation unit 4A22 and the switching condition storing unit 10 are engaged in execution and confirmation of the current operation, the software processing unit 4A1 and the part to receive signals from the software processing unit 4A1 are making preparations to start the next stage by engaging in signal exchanges concerning the next-stage operation and processing.

The control command issuance by the software processing unit 4A1 is carried out through the following two processes. In the first command issuance process, the software processing unit 4A1 transmits, by referring to the external main storage device 4A12, the data group H1 representing switching conditions, indicated in FIG. 6, for the control tasks and operation tasks concerning gripping control altogether to the switching condition storing unit 10. In the second command issuance process, the software processing unit 4A1 enters, by referring to the external main storage device 4A12, the operation parameters p, indicated in FIG. 7, in the FIFO memory unit 20, shown in FIG. 4, as a serial data group J1.

At this point of time, operation parameters p have only been stored in the FIFO memory unit 20. Subsequently, the memory selection unit 30 stores the data group J1 including a series of parameters for respective operation tasks in plural parameter storing memories 40 such that the serial data group J1 including the parameters for respective operation tasks are allocated to different parameter storing memories 40, respectively. Referring to the illustrated example: storing parameter p1 is storing the parameter for the operation task for bolt A; storing parameter p2 is storing the parameter for the operation task for bolt B; and storing parameter p3 is storing the parameter for the operation task for bolt C. This means that, at this timing, only the transfer of the parameters p is being executed. This applies also to the switching condition storing unit 10. Namely, the data group H1 representing switching conditions for the control tasks and operation tasks concerning gripping control have only been received, and, during this period, whether the switching condition for the preceding task in the preceding stage has been met is being determined.

When time point t1 is reached, the switching condition storing unit 10 confirms that the switching condition for the preceding task has been met, accordingly reports to the operation unit 4A22, and the operation unit 4A22 stops operation of the preceding task. That the switching condition for the preceding task has been met is also reported to the software processing unit 4A1. The software processing unit 4A1 transfers, based on the conditions determined in the switching condition storing unit 10, the parameters P3 stored in the parameter storing memories 40 to the operation unit 4A22 via the memory selection unit 50 of the parameter control unit 4A21 and, subsequently, deletes all contents of the memories. The operation unit 4A2 to which the parameters have been transferred starts execution using the parameters while retaining the parameters. Subsequently, every time a switching condition is met, the operation unit 4A22 executes operation using the selected parameter.

The software processing unit 4A1 issues, at time point t2 subsequent to the issuance of the direction for parameter deletion, a position control command to the logic circuit unit 4A2 side, and, subsequently, continues processing execution for each part based on the same logical judgment as described above. The contents of the processing will be easily understood from the above description, so that further description is omitted herein.

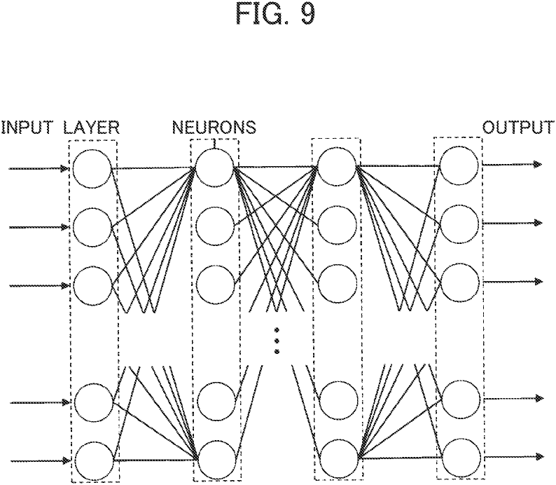

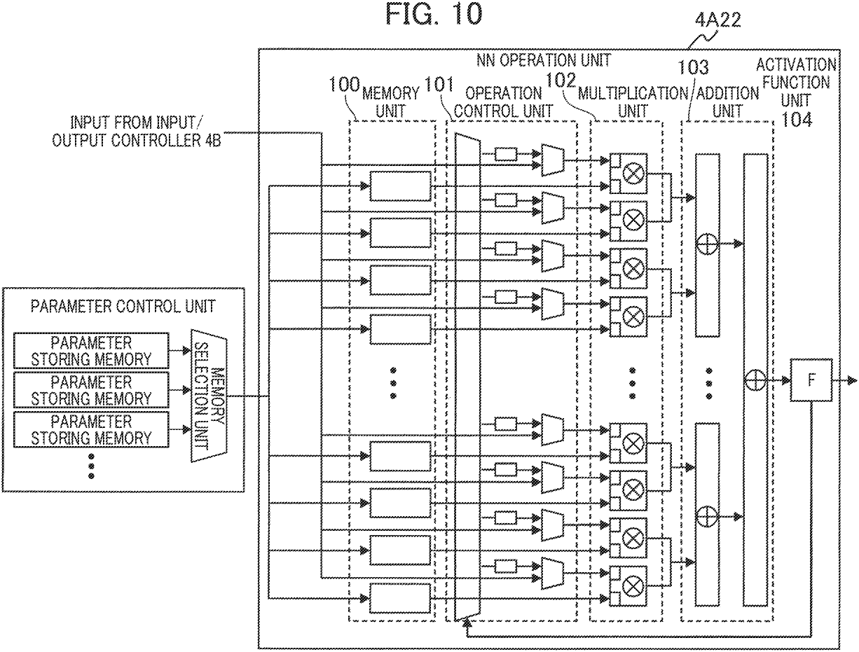

The normal-time operation unit 4A22 shown in FIG. 4 is preferably configured with an NN operation unit to perform network processing. FIG. 9 is a conceptual diagram of well-known network processing. In this example, sensor signals from the input/output controller 4B or data fed back from actuators are used as inputs, and parameters from the parameter control unit 4A21 are used as weights to be added to neurons in subsequent layers.

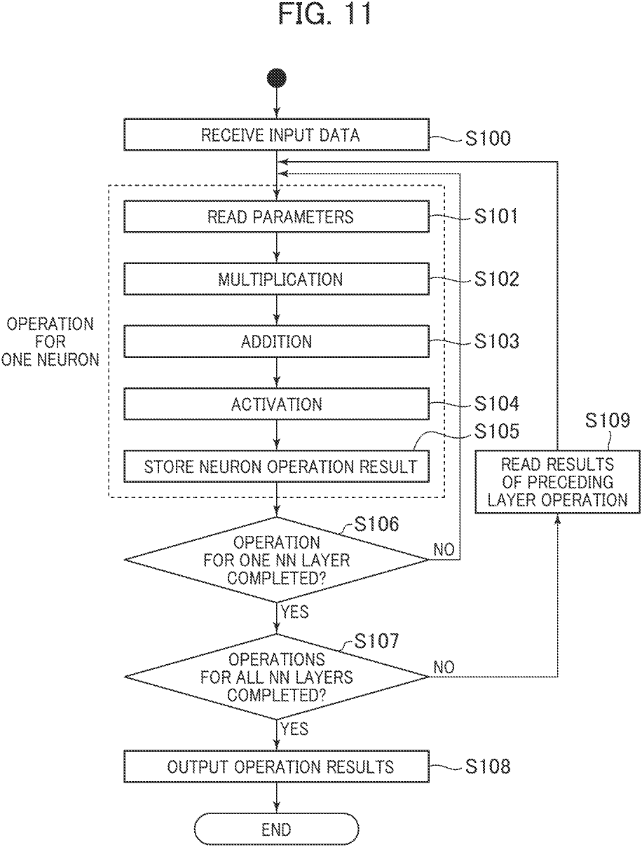

FIG. 10 shows a specific configuration example of an NN operation unit to perform network processing, the NN operation unit being configured including a memory unit 100 including plural memories to which sensor signals from the input/output controller 4B are inputted, plural operation control units 101, a multiplication unit 102 to carry out weighting using parameters, an addition unit 103, and an activation function unit 104. A neuron is processed through a series of processing performed by the above units, then processing is further continued to process other neurons in the same layer or in other layers while inputs and parameters are appropriately changed and the results of processing such other neurons are sequentially outputted.

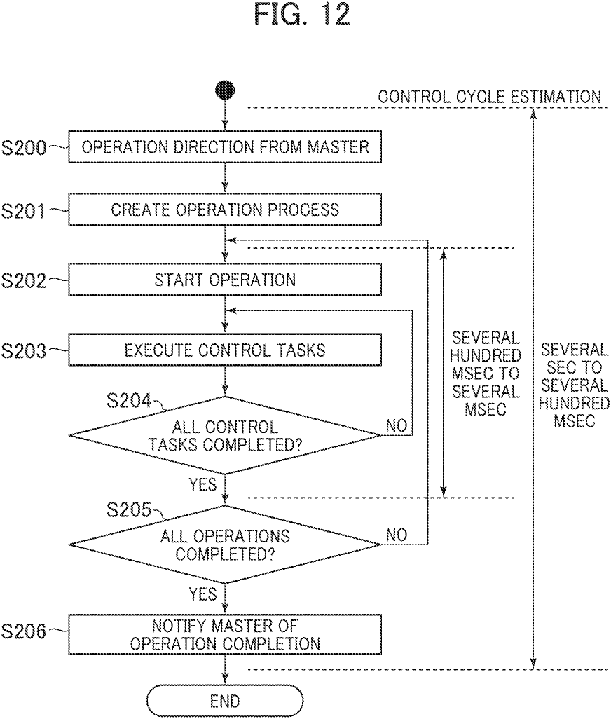

FIG. 11 is a flowchart of a procedure for processing performed by the NN operation unit. According to the flowchart, in processing step S100, parameter and sensor signal inputs are received. Processing steps S101 through S105 represent the part of operation required to process one neuron in the network shown in FIG. 9. In the present example, parameter reading (processing step S101), multiplication (processing step S102), addition (processing step S103), activation processing (processing step S104), and storing of the result of neuron operation (processing step S105) are executed as one set.

Processing step S106 makes neuron processing for a layer repeated until all neurons in the layer have been processed. Similarly, processing step S107 makes layer-by-layer neuron processing repeated until all of the plural layers have been processed. In this case, until all layers have been processed, every time processing for a layer is started, the operation result of the preceding layer is read out. Finally, in processing step S108, completion of processing for all layers is confirmed.

The NN operation unit shown in FIG. 10 configures an inference accelerator. Generally, control operations, for example, for high-speed, high-precision positioning to be performed by industrial robots are required to render a high control cycle, for example, on the order of several ms to several hundred µs and high real-timeness. By using a dedicated accelerator including an FPGA, real-time, high-speed inference operations can be realized.

In the totally coupled network shown in FIG. 10, plural product-sum operations are executed for each neuron. According to the present invention, with the data-dependency in product-sum operations taken note of, operations are speeded up by arranging operation units in parallel and implementing pipelined processing. Specifically, since there is no data dependency between inputs for memory reading, multiplications, and additions performed for product-sum operations, by arranging, in parallel, as many operation units and weight storing memories as required for the number of neurons of each intermediate layer of the neural network, processing can be executed simultaneously for the neurons included in each layer.

When, on the other hand, there is data dependency, overall inference operations can be speeded up by implementing processing-by-processing pipelining and, thereby, shortening the processing execution cycle. Furthermore, for the operation units, to ensure actuator control accuracy, a single-precision floating point format is used, and, for the memories, weights can be changed every time learning is made.

FIG. 12 represents average processing time relationships in a series of processing performed in the lower-order control device 4 shown in FIG. 2. The processing is divided into processing steps S200 to S206, representing the time from when an operation command is received from the high-order control device 3 in processing step S200 to when the completion of the operation is reported to the high-order control device 3 in processing step S206. The time ranges generally from several seconds to several hundred milliseconds. Also, the time from when the operation process is created in the lower-order control device 4 (processing step S201), then, the operation is started by the logic circuit unit 4A2 (processing step S202) to when the entire operation is completed (processing step S204) ranges generally from several hundred milliseconds to several milliseconds.

According to the industrial robot control system and control method therefor of the present invention described above, a module system for robots which is suitable for autonomous robots to undertake field operations can be provided.

### LIST OF REFERENCE SIGNS

1: Arm, 2: Hand, 2a: Positioning mechanism, 2b: Camera, 2c: Wrist mechanism, 2d: Gripper mechanism, 3: Higher-order control device, 4: Lower-order control device, 4A: Master controller, 4A2: Logic circuit unit, 4A1: Software processing unit, 4A11: Bus communication unit, 4A21: Parameter control unit, 4A22: Normal-time operation unit, 4A23: Input/output control unit, 4A24: Emergency operation unit, 4B: Input/output controller, 10: Switching condition storing unit, 20: FIFO memory unit, 30: Memory selection unit, 40: Parameter storing memory, 50: Memory selection unit

1. A module system for robots, the module system being for, by being linked to a drive mechanism and a sensor of a robot, controlling the drive mechanism,
the module system comprising a software processing unit, a logic circuit unit, and an input/output controller linked to the drive mechanism and the sensor,
wherein the software processing unit stores switching conditions for switching a plurality of control tasks executed in a series of operation processes to be executed in the drive mechanism and parameters for use in operation tasks executed in the control tasks, the software processing unit also transmitting the switching conditions and the parameters to the logic circuit unit and specifying a next operation process to be executed, and
wherein the logic circuit unit: confirms, based on sensor signals from the input/output controller, establishment of the switching conditions and controls starting and ending of the plurality of control tasks; temporarily retains the parameters and uses the parameters in the operation tasks to be executed in the next operation process specified for execution; and controls, via the input/output controller, the drive mechanism according to operation results of the operation tasks.

2. The module system for robots according to claim 1,
wherein the module system is connected to a higher-order control device for controlling the robot as a whole and performs control in the drive mechanism.

3. The module system for robots according to claim 1,
wherein the software processing unit retains and transmits, to the logic circuit unit, switching conditions for a plurality of operation tasks executed in the control tasks, and
wherein the logic circuit unit confirms, based on sensor signals from the input/output controller, establishment of the switching conditions for the operation tasks and controls starting and ending of the plurality of operation tasks.

4. The module system for robots according to claim 1,
wherein the software processing unit stores, as serial data, and transmits, to the logic circuit unit, parameters for use in a plurality of operation tasks executed in the control tasks, and
wherein, when temporarily retaining the parameters, the logic circuit unit retains the serial information as parameters divided according to the plurality of operation tasks.

5. The module system for robots according to claim 1,
wherein an operation unit to execute operations of the operation tasks is configured with a neural network, and a plurality of storage units to store a plurality of sensor signals from the input/output controller, a plurality of operation control units, a plurality of multiplication units, a plurality of addition units, and an addition-result activation function unit are provided, the neural network using the units to perform processing of a neuron at a time and repeating neuron-by-neuron processing.

6. The module system for robots according to claim 1,
wherein the logic circuit unit is configured with hardware.
